(19) United States
(12) Patent Application Publication
(10) Pub. No.: US 2010/0023342 A1
(43) Pub. Date: Jan. 28, 2010

(54) USE OF CLINICAL LABORATORY DATA TO IDENTIFY INPATIENT HOSPITAL COMPLICATIONS

(75) Inventors: Richard Johannes, Newton, MA (US); Robert Darin, Westford, MA (US)

Correspondence Address: McDermott Will & Emery LLP, 11682 EL CAMINO REAL, SUITE 400, SAN DIEGO, CA, 92130-2047, US

(73) Assignee: Cardinal Health 303, Inc., San Diego, CA (US)

(21) Appl. No.: 12/180,428

(22) Filed: Jul. 25, 2008

(51) Int. Cl. G06Q 50/00

(52) U.S. Cl. 705/2

(57) ABSTRACT

Described herein are systems and methods for identification of complications by identifying physiological changes associated with these complications that are reflected in laboratory results. In some embodiments, systems and methods are described for identifying trends in the laboratory data over time and associating those trends with degrees of risk or complication factors that are established through retroactive analysis of similar laboratory data across a plurality of care facilities or patient groups. In some embodiments, a benchmark may be established, based on laboratory results, against which care facilities can retrospectively compare patient outcomes within their own facility or among various patient groups.

### STATEMENT AS TO RIGHTS TO INVENTIONS MADE UNDER FEDERALLY SPONSORED RESEARCH OR DEVELOPMENT

Not Applicable.

### CROSS-REFERENCES TO RELATED APPLICATIONS

Not Applicable.

### FIELD

The disclosure relates generally to systems and methods for identifying possible adverse outcomes for patients in a healthcare facility, and, more specifically, the disclosure relates to systems and methods for identifying, based on laboratory data, possible complications that might arise during patients' stay at the healthcare facility and using the laboratory data and records of patient progress to, for example, compare healthcare quality at different facilities, to compare different patient populations, or to improve policies or procedures within a healthcare facility.

### BACKGROUND

When a patient is admitted into a hospital, or other healthcare facility, laboratory data is routinely obtained from the patient. Different laboratory data is obtained through blood tests, urine tests, vital signs test, and similar tests. These data are used to establish a baseline condition of the patient to which subsequent results of the patient's condition may be compared.

The data that are often reviewed during the patient's stay are those associated with the condition for which the patient has been admitted, as changes in these data may indicate improvement or deterioration of the patient's condition. However, it is often the case that a patient will be admitted to the care facility for a primary condition and other conditions, secondary conditions, or complications, will subsequently arise.

### SUMMARY

Described herein are systems and methods for identification of secondary conditions, or complications, that arise during a patient's stay at a health care facility by identifying physiological changes associated with these complications that are reflected in laboratory results. In some embodiments, systems and methods are described for identifying trends in laboratory data of patients at a healthcare facility over time and associating those trends with degrees of risk, or complication factors, for patients at that facility. Facilities can compare results associated with its own patients to risks, or complication factors, for similar patients at other healthcare facilities. These comparisons can be used by a facility to change internal operations or policies to bring the risks in line with those of similar facilities. The systems and methods can also be used to more accurately project resources required for patients treated at the healthcare facility.

In some methods described herein for identifying complications of a patient of a care facility, the methods include obtaining at least a first set of laboratory data of a first patient and a second set of laboratory data of the first patient, determining a data trend that represents a difference between the first set of data and the second set of data, and obtaining at least a first set of laboratory data of a second patient. Some methods also include comparing at least part of the first set of laboratory data of the second patient with the data trend to calculated trends associated with a plurality of complications and assigning a risk value, based on the data trend, that represents a likelihood that the patient has developed or will develop at least one complication. Some methods further include outputting, to an output module the risk value and the at least one complication.

Some methods provide that calculated trends are calculated based on the laboratory data from a plurality of patients at a plurality of care facilities. Some methods provide that the first and second sets of data of the first patient include data from at least one of a blood urea nitrogen (BUN), creatinine, glucose, albumin, potassium, bilirubin, creatinine phosphokinase (CPK), hemoglobin, sodium, and white blood cell (WBC) test. The complications associated with the calculated trends can include at least one of acute renal failure, anemia, heart failure, myocardial infarction, nonhemorrhagic stroke, pancreas disease, renal disease, asthma, acute liver disease, arterial and/or aneurysm complications, fractures, gastro-intestinal tract complications or obstruction, liver and/or biliary disorder, arrhythmia, chronic lung disorders, and pneumonia.

In some methods, the risk value includes a percentage of the likelihood that the patient has developed or will develop a complication. In some methods, the data trend of one healthcare facility is compared with the data trend of a second healthcare facility to, for example, determine relative healthcare quality between facilities or to internally improve facility policies or procedures relating to care of patients with likelihoods of developing complications. Comparisons for improving healthcare quality can be used to decrease patient length of stay, to decrease possible complications during stay, or to otherwise increase patient satisfaction.

In some methods, the first set of data represents a baseline value of laboratory data for the patient upon admittance of the patient to the care facility. Some methods provide that the risk value, or complication factor, assigned to the patient include a low, moderate, or high likelihood designation based on a comparison of at least part of the data trend with the baseline value. In some methods, the low likelihood designation is assigned to a patient whose data trend has progressed to between about 25% and about 40% from the baseline value to a threshold value associated with a presence of a complication. In other methods, the moderate likelihood designation is assigned to a patient whose data trend has progressed to between about 35% and about 60% from the baseline value to a threshold value associated with a presence of a complication. And in yet further methods, the high likelihood designation is assigned to a patient whose data trend has progressed between about 50% and about 75% from the baseline value to a threshold value associated with a presence of a complication.

Some methods described herein for identifying the likelihood of complications of a patient include obtaining at least a set of the patient's laboratory data; comparing at least part of the patient's laboratory data to threshold values associated with a plurality of complications, the threshold values being based on laboratory data from a plurality of patients at a plurality of care facilities; and assigning a risk value, based on the patient's laboratory data in view of the threshold values, that represents a likelihood that the patient has developed or will develop at least one complication. Some methods further include outputting, to an output module the risk value and the at least one complication.

In some methods, the patient's laboratory data include data from at least one of a blood urea nitrogen (BUN), creatinine, glucose, albumin, potassium, bilirubin, creatinine phosphokinase (CPK), hemoglobin, sodium, and white blood cell (WBC) test. In some methods, the complications associated with the threshold values include at least one of acute renal failure, anemia, heart failure, myocardial infarction, nonhemorrhagic stroke, pancreas disease, renal disease, asthma, acute liver disease, arterial and/or aneurysm complications, fractures, gastro-intestinal tract complications or obstruction, liver and/or biliary disorder, arrhythmia, chronic lung disorders, and pneumonia. Some methods provide that the risk value assigned to the patient comprises a low, moderate, or high likelihood designation based on a comparison of the patient's laboratory data with the threshold value. In some methods, the risk value, or complication factor, assigned to the patient includes a percentage of the likelihood that the patient has developed or will develop a complication.

In some embodiments, a system for determining a likelihood of a patient outcome is described. Some embodiments of the system include a database, comprising at least one of a result and a trend of laboratory data, the at least one of the result and the trend being associated with an outcome of a plurality of patients. The system may further include a processor that receives laboratory results for a patient, compares at least part of the results with the at least one of the result and the trend to determine a likelihood of the patient's outcome, and outputs a signal indicative of the likelihood. Some embodiments further include an output module, connected to the processor, configured to receive the signal and to communicate to a caregiver the likelihood of the patient's outcome. In some embodiments, the outcome comprises whether the patient has developed or will develop a complication.

Some embodiments described herein include a computer readable medium, including instructions that, when executed, cause a computing device to perform a method that comprises obtaining at least a set of a patient's laboratory data; comparing at least part of the patient's laboratory data to threshold values associated with a plurality of complications, the threshold values being based on laboratory data from a plurality of patients at a plurality of care facilities. The method further includes assigning a risk value, based on the patient's laboratory data in view of the threshold values, that represents a likelihood that the patient has developed or will develop at least one complication; and generating an output signal indicative of the risk value and the at least one complication.

For purposes of summarizing the disclosure, certain aspects, advantages, and novel features of the disclosure have been described herein. It is to be understood that not necessarily all such advantages may be achieved in accordance with any particular embodiment of the disclosure. Thus, the disclosure may be embodied or carried out in a manner that achieves or optimizes one advantage or group of advantages as taught herein without necessarily achieving other advantages as may be taught or suggested herein.

### BRIEF DESCRIPTION OF THE DRAWINGS

A general architecture that implements various features of the disclosure will now be described with reference to the drawings. The drawings and the associated descriptions are provided to illustrate embodiments of the disclosure and not to limit the scope of the disclosure. Throughout the drawings, reference numbers are re-used to indicate correspondence between referenced elements.

FIG. 1 illustrates embodiments of systems for identifying inpatient complications.

FIG. 2 illustrates embodiments of methods for identifying inpatient complications.

FIG. 3 illustrates a chart with data in connection with adjusting clinical data in estimating length of stay at the care facility.

FIG. 4 illustrates a chart with data in connection with adjusting clinical data relating to mortality.

FIG. 5 illustrates a chart with data that associates an increase in frequency of abnormal lab results with higher mortality rates.

FIG. 6 illustrates a chart with data demonstrating an increased percentage of abnormal labs among increased clinical risk scores for patients with pneumonia.

FIG. 7 illustrates a chart with data that associates an increase in the number of abnormal lab results with higher mortality rates for patients with nonhemorrhagic stroke.

FIG. 8 illustrates a chart demonstrating a correlation between increased mortality ratios and a change from normal to abnormal lab results.

FIG. 9 is a chart that provides examples of types of lab data that can be used for risk adjustment.

FIG. 10 provides a chart that associates trends in mortality rates with trends of albumin levels.

### DETAILED DESCRIPTION

The systems and methods described herein allow hospitals, researchers, and other entities to identify which patients developed complications in the hospital through the use of automated lab data acquisition, analysis, and reporting. Historically this has been very difficult to do in a standardized approach across multiple care facilities, as the data is not readily available and provided in a manner that can permit detailed patient analysis. Current diagnosis codes used for billing data do not allow for adequate specificity to identify complications from patient comorbidities that were present when the patient was admitted.

In some embodiments, the disclosure provides additional patient outcome tools to measure hospital quality and to assist hospitals in internal quality improvement activities through retrospective analysis of patient lab data. The present disclosure provides methodologies, approaches, and systems to measure complications using automated data across a wide range of surgical and medical inpatient cases. These methodologies include using lab data, and particularly examining lab data over time, in measuring patient statistics that have standard lab results at the beginning of the patients' stay at the care facility. These patients can begin with normal laboratory profiles, and then through tracking the laboratory tests and identifying how the test results change over time during the patients' stay, the systems identify patients that have developed a complication during the course of their hospital stay. These data can be used to compile benchmarks across several care facilities for determining what care facilities can expect in specific cases and how certain trends in lab results can affect a patient's condition and prognosis.

Automated laboratory data can also be used in embodiments and methods described herein to identify which patients were admitted with lab values in a normal clinical range but then developed abnormal lab values, and those patients can be “marked” as having laboratory-identified complications. These markers can be identified across a wide variety of lab tests, within the hospital or among several hospitals, specific to an individual patient disease or disease group for improvement of healthcare quality or policies and procedures associated with caring for patients similarly marked. For example, commonly used lab tests to identify complications and calculate risk values, or complication factors, could include sodium, creatinine, albumin, glucose, white blood cell count, and hemoglobin. A degree of risk, or indication of the severity of complications, can also be determined by calculating the likelihood of lab-related complications arising with certain lab results. The analysis of determining the degree of risk can be informed and become more accurate by obtaining multiple results from multiple care facilities.

Some complications that can be associated with the above-mentioned lab tests include acute renal failure, anemia, heart failure, myocardial infarction, nonhemorrhagic stroke, pancreas disease, renal disease, asthma, acute liver disease, arterial and/or aneurysm complications, fractures, gastrointestinal tract complications or obstruction, liver and/or biliary disorder, arrhythmia, chronic lung disorders, and pneumonia. In some embodiments, a complication factor can be determined that is based on the laboratory results and that provides a quantifiable projection of the likelihood that a complication might arise. As used herein, the term complication factor is a broad term that is intended to have its ordinary meaning, which includes, without limitation, a factor that characterizes the likelihood that a complication will arise or has arisen during a patient's stay are the care facility.

The systems and methods, in some embodiments, can generate models that are used to identify what the enhanced risks are as a function of certain abnormal lab results. For example, mortality risk can increase between three fold and ten fold if certain levels of laboratory abnormalities occur in the care facility, and the models can be compared with patients' lab results to monitor and gauge the progress of the care facility's treatment of patients' with similar conditions. In some embodiments, the models can include benchmarks for care facilities to identify relative performance as to how many patients in a specific disease state develop a lab-identified complication and to measure the financial and mortality impact associated with those patients with lab-identified complications. The benchmarks can also be used as standards against which care facilities can be compared, such as when determining to which care facility certain incentives or awards should be applied.

The systems and methods can also be implemented on a basis where lab results are monitored or measured, and when new lab results are received for patients, these lab results are compared against prior lab results, the models, or the benchmarks, for consideration of whether the models or benchmarks should themselves be modified for a care facility, patient group, or across multiple facilities. The results of the comparison may be used as a risk marker, or complication marker or factor, to identify, for example, quality issues or opportunities within a care facility.

In some embodiments, the methods rely on computer systems that receive lab data in a batch format. Calculations are then made regarding changes in lab test values to identify which patients have developed a lab-identified complication or comorbidity, while at the care facility. These markers then can retrospectively be combined with diagnosis, mortality, length of stay, and financial information to provide benchmarking and quality improvement services.

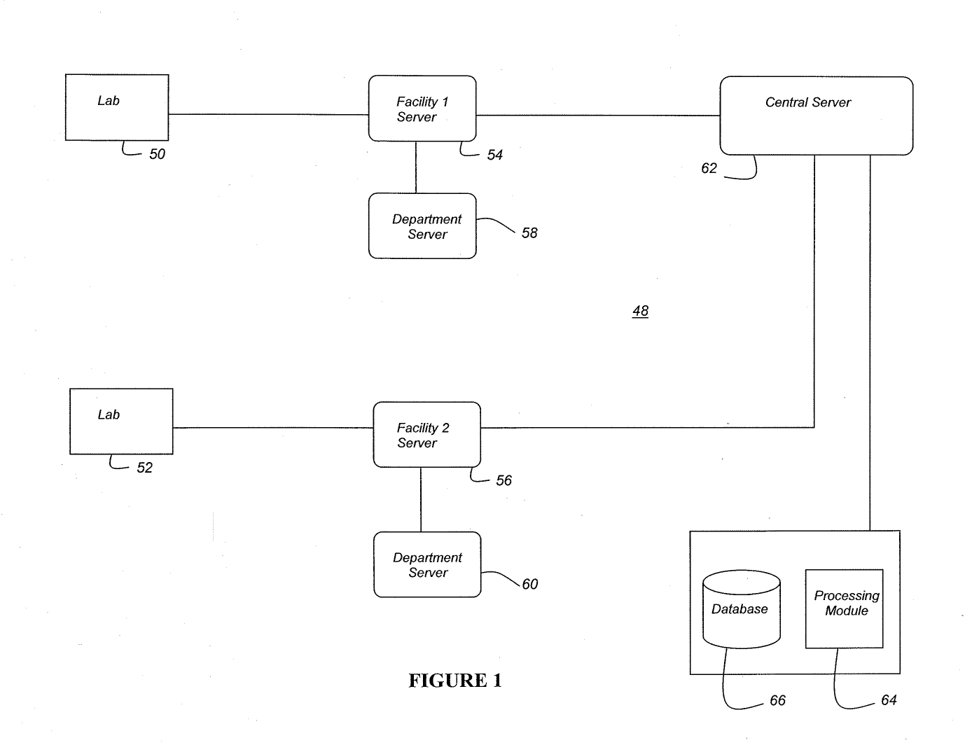

With reference to FIG. 1, an embodiment of a system 48 for identifying possible adverse outcomes for a patient during the patient's stay in a healthcare facility is schematically depicted. Labs 50, 52, which may be the same or separate labs, obtain and analyze the results of laboratory tests. The labs 50, 52 contain computers or other processors (not shown) connected to a care facility server 54, 56. Facility 1 Server 54 can be associated with the same or a different care facility than that of Facility 2 Server 56. Each facility server 54, 56 is preferably in communication with a corresponding department server 58, 60 and with a central server 62. The central server 62 is connected to a processing module 64 and a database 66. The department servers 58, 60 function, in part, to transmit information received from the corresponding facility servers 54, 56, which obtain the information from, among other things, the labs 50, 52 and the central server 62.

FIG. 1 depicts one arrangement that the system 48 can have, but several other arrangements could also be used and accomplish the same purposes. For example, in some embodiments, the labs 50, 52 can be connected directly to the central server 62 without passing through a facility server 54, 56. The lab results can be sent simultaneously to the central server 62 and to the facility servers 54, 56. Additionally, although FIG. 1 suggests that there are two separate labs 50, 52 and two separate facilities 54, 56, in some embodiments there is only one lab 50 and/or one facility in the system 48. Similarly, in some embodiments, there are more than two labs 50, 52 and/or more than two facilities in the system 48.

In some embodiments, the entire system 48 is contained within a single care facility. In some embodiments, each facility server 54, 56 is associated with a different healthcare facility, and the central server 62 is contained within one of the care facilities. In yet further embodiments, each facility server 54, 56 is associated with a different healthcare facility, and the central server 62 is not contained in any of the care facilities. For example, in some embodiments, the central server 62 is maintained by a third party that provides its services of lab analysis to the care facilities. In some embodiments, the connection between the care facilities and the central server 62 is a secure connection for transmitting sensitive patient data. In another example, the central server 62 is maintained by a third party that interlinks the facility servers with a fourth party that provides lab analysis and communicates the results of the lab tests to the facility servers 54, 56 through the third party central server 62.

In application, some embodiments provide that the lab data is sent from the lab 50 directly to the central server 62, or to the central server 62 through a facility server 54, 56, which directs the lab data to the processing module 64 and database 66. The data is analyzed by the processing module 64 and compared to models, benchmarks, or thresholds maintained in the database to determine if there are any lab-related abnormalities. Upon completing the analysis the results of the lab analysis are then sent to the facility servers 54, 56 directly or through the central server 62. The facility servers 54, 56 can then determine which department of the facility to direct the results of the lab analysis. Server arrangements and capabilities, in some embodiments, can be similar to those described in U.S. patent application Ser. No. 11/449,450, assigned to Cardinal Health 303, Inc., the entirety of which is hereby incorporated by reference.

The system 48 may be, for example, a local area network (LAN), a wide area network (WAN), Inter- or intranet based, or some other communication network designed to carry signals allowing communications between the various information systems and servers in and outside the facilities. The system 48 may include, for example, an Ethernet (IEEE 522.3), a token ring network, or other suitable network topology, utilizing either wire or optical telecommunication cabling. In some embodiments, the system 48 may include a wireless system, utilizing transmitters and receivers positioned throughout the care facility and/or attached to various subsystems, computers, patient care devices and other equipment used in the facility. In such wireless systems, the signals transmitted and received by the system 48 could be radio frequency (RF), infrared (IR), or other means capable of carrying information in a wireless manner between devices having appropriate transmitters or receivers.

Each of the various modules and/or servers can include a combination of hardware, such as digital computers, which may include one or more central processing units, high speed instruction and data storage, on-line mass storage of operating software and short term storage of data, off-line long-term storage of data, such as removable disk drive platters, CD ROMs, or magnetic tape, and a variety of communication ports for connecting to modems, local or wide area networks, and printers or monitors for generating or viewing reports. Such systems may also include remote terminals including video displays and keyboards, touch screens, printers and interfaces to a variety of clinical devices. The processors, or CPUs, of the various modules and/or servers are typically controlled by a computer program or programs for carrying out various aspects of the present disclosure and basic operational software, operating system, or another operating program. The operational software will also preferably include various auxiliary programs enabling communications with other hardware or networks, data input and output, and report generation and printing, among other functions.

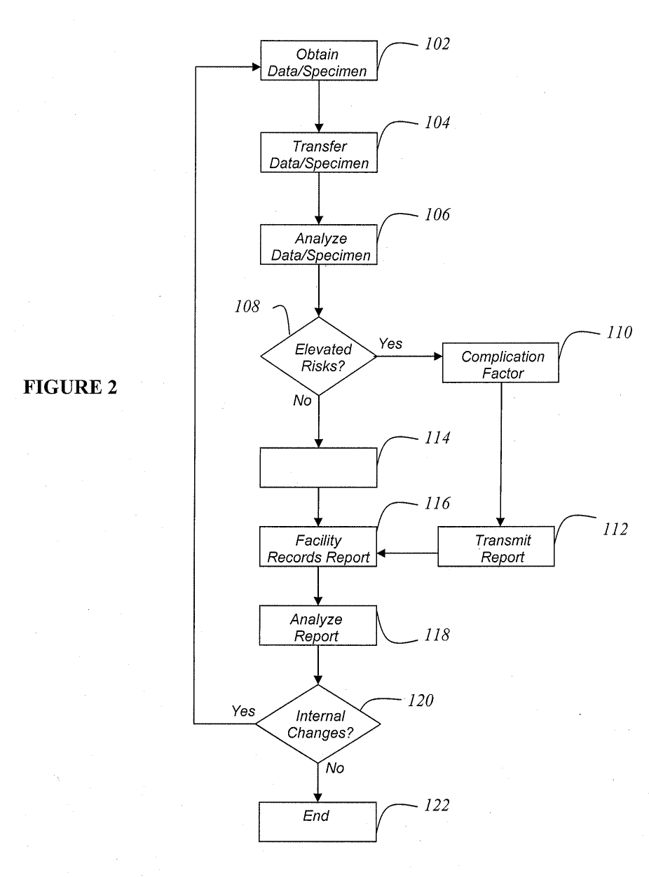

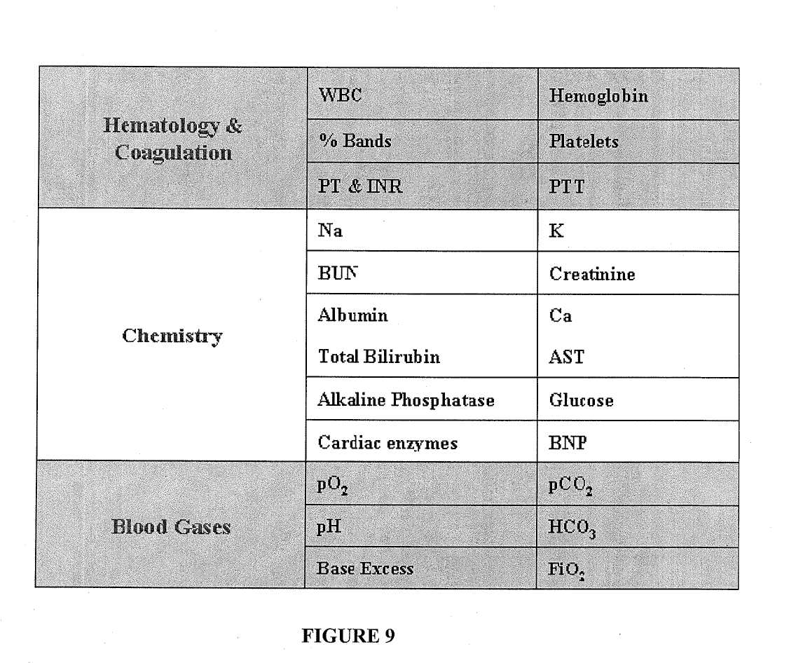

Some methods of care facility monitoring are illustrated in FIG. 2. In the method outlined, the first step 102 is to obtain the data or specimen from a patient or a group of patients. The data or specimen can provide pertinent information to one or more of the following: blood urea nitrogen (BUN), creatinine, sodium, potassium, alk phos, bilirubin, albumin, AST, arterial blood gases, O2 saturation, Hbg, white blood cell (WBC), bands platelets, proTime, PTT, glucose, BNP, cardiac enzymes, and creatine phosphokinase (CPK). Other exemplary types of data can include those listed in FIG. 9. The above is exemplary only, as other types of data or results can be obtained.

Step 104 is the transfer of the lab data or specimen to the lab for analysis. This transfer can be performed by the actual transfer of one or more specimen or the transmission of data to be analyzed by the laboratory. In Step 106, the laboratory analyzes the lab data and/or specimen, producing lab results, and the lab results are compared by a processor, to the models, benchmarks, or thresholds for determining whether values of any of the lab data and/or specimen indicate complications that may arise or that might have arisen during treatment of the patient or group of patients at the care facility. The lab results can also be compared to previous lab results to determine if any trends in changing lab results indicate an elevated risk (Step 108) of additional complications.

In some embodiments, the comparison of the lab results with the models, benchmarks, or thresholds is conducted by processing module 64. While FIG. 1 suggests that the processing module 64 is a separate module, and is only connected to the laboratory or care facility through one or more servers, it is also possible that the processing module 64 is provided within the laboratory or care facility. For example, the processing module 64 could be contained within a computer that is located at the laboratory or the care facility. Is some embodiments where the processing module 64 is located at the laboratory or the care facility, the models, benchmarks, or thresholds, against which the lab results are compared, can be delivered from the database 66 to the processing module 64 at the laboratory or care facility.

In some embodiments, once the lab results are obtained by the laboratory, the laboratory queries the database 66, which may be located remotely or even within the same computer or computing system as the processing module 64, for the models, benchmarks, or thresholds corresponding to the lab results. Upon receipt of the information from the database 66, the processing module 64 can perform the comparison and report on the results of the comparison. In some embodiments, the processing module 64 can receive instructions from a program, or other operating instructions, provided on a computing system, or other computer readable medium. In some embodiments, the program, or other operating instructions, can instruct the computing system to perform all or some of the steps of the methods described herein. For example, in some embodiments, the program, or other operating instructions, can instruct the computing system to perform the obtaining, analyzing, comparing, and/or reporting steps of the methods described herein.

If the lab results indicate that there is an elevated risk or complication factor, Step 110 is to determine a risk or complication factor or likelihood of suffering from the at-risk complication. In some embodiments, a threshold value of a particular lab result may correlate with the presence, or likelihood, of a complication.

In some embodiments, specific values or trends of the lab results may be associated with a risk level of low, moderate, and severe likelihood of a complication. In some embodiments, the assignment of low, moderate, and severe likelihoods may be applied as a percentage of progression of a lab result between a baseline value of the lab result (e.g., when the patient enters the care facility) and a determined threshold value (e.g., a value calculated across multiple care facilities, multiple patient groups, multiple facility departments, etc.). For example, if a particular lab result associated with a complication progressed from a baseline value to between about 25% to about 40% of a threshold value, a low likelihood may be applied to the lab results. If the lab result progressed from the baseline value to between about 35% to about 60%, a moderate likelihood may be applied to the lab results. And if the lab result progressed from the baseline value to between about 50% and about 75% of the threshold value, a severe likelihood or risk may be applied to the lab results.

In some embodiments, combinations of risk factors may be applied for some values that are between the low, moderate, and severe likelihoods described above. For example, if a particular lab result progressed from a baseline value to a value of about 38% of the threshold value, which is listed under both the ranges described above for low and moderate, a low-to-moderate likelihood of a complication may be applied. If a lab result progressed from a baseline value to a value of about 55% of the threshold value, a moderate-to-severe likelihood of a complication may be applied. Accordingly, a spectrum of likelihoods of complications may be associated with abnormal lab results.

In some embodiments, when an acceptable cross-section of results are available, a percentage likelihood may be associated with any abnormal lab results. For example, it may be the case, in some instances, that a 25% progression of lab results from a baseline value toward a threshold value is found to be associated with a 10% likelihood that a complication has arisen or will arise. Likewise, it may be the case, in some instances, that a 75% progression of lab results from a baseline value toward a threshold value is found to be associated with a 95% likelihood that a complication has arisen or will arise. When an acceptable cross-section of results are available in the database 66 to associate a percentage likelihood with the lab results, this percentage can be provided in addition to, or in place of, the levels of low, moderate, and severe described above.

Following the determination of the level of risk associated with one or more abnormal lab results, a report can then be prepared and transmitted, as identified in Step 112. The report preferably contains the abnormal lab results and an associated risk, or complication, factor. In some embodiments, the risk factor can be the identification of a low, moderate, or severe likelihood of a complication, a percentage likelihood of a complication, or the like. In some embodiments, the report may be provided with merely a listing of the lab results and associated threshold values associated with the lab results. As shown in Steps 112 and 116 of FIG. 2, the report is preferably transmitted to the facility for recordation of the report in the facility's internal records, and the report can then be compared with the facility's operations in comparison to, for example, industry benchmarks, other facilities, or other patient groups.

If, during Step 108, it is determined that there are no elevated risks associated with the lab results, a clear report is preferably prepared and transmitted to the facility, as shown by Step 114 in FIG. 2. The clear report is preferably received by the facility, in Step 116, for recordation of the report in the facility's internal records.

When a report is received, retroactive corrective action can be taken by the facility to improve procedures or policies that will advance the facility's performance with respect to patient care. If continued changes are required to internal policies and procedures, an iterative process may be employed to assist with advancing the facility's performance toward an acceptable or desired level, as shown by Step 120. If the performance of a facility is in line with or better than that of the benchmark levels or of other facilities, and internal changes to treatment procedures or policies do not appear to be required, the analysis can move to Step 122, which completes the analysis process.

Following a patient's stay at the care facility, a report of the patient's lab results, trends, and treatment are preferably provided to the database 66 to provide further data for identifying possible complications and risk factors for future patients in the same and/or different care facilities and across different patient groups. As exemplified by FIG. 2, the aggregate retroactive analysis of several patients in one or more facilities will permit more accurate determination of thresholds for identifying complications, establishment of benchmarks against which facilities or patient groups can be compared, and increased accuracy for projecting patient complications and planning protocols.

Methods used for similar purposes can be modified to incorporate the systems and methods described herein. For example, clinically risk adjusted analyses, described in further detail below, can be enhanced with the systems and methods described herein to provide quantifiable measures by which patient conditions and/or prognoses are expressed.

Health care facilities are often evaluated and held accountable for the outcome of their patients. These outcomes can be acceptable values and/or quantifiable performance parameters that are based on accumulated data from multiple patients and care facilities. Examples of these outcomes can include costs, service consumption, and mortality rates. These outcomes can also be factored into the risk or complication factors. To be meaningful, the outcomes under scrutiny are important to the patients, the facility, or the health care system as a whole, relatively common, and linked temporally and causally to the care provided. In addition, outcomes findings can be adjusted for patient risk factors, with the goal of accounting for pertinent clinical characteristics before drawing inferences about the effectiveness or quality of care. Risk adjustment “levels the playing field” in comparing outcomes across multiple providers and can be determined based on the laboratory data that is analyzed through the disclosed systems and methods.

Performing clinically credible risk adjustment, however, can be difficult. The risk adjustment may be modified with different degrees for each variable being considered. A patient's clinical risk score is sometimes calculated based on the patient's clinical data upon being admitted to the care facility. The clinical risk score is a unitless number that is associated with the severity of a patient's condition, and which can incorporate possible comorbidities or complications. Calculation of a clinical risk score can vary depending on, among other things, the disease being diagnosed, the patient's clinical data, and weighted variables in the determination. For example, in some diseases, the clinical risk score may be tied to a particular lab result, while in other diseases, that particular lab result may not be relevant to a calculation of the clinical risk score.

Clinical risk scores are often reflected on a scale ranging from 0-5, depending on the severity of the patient's condition. A clinical risk score of 0-1 can reflect a low or slight risk associated with complications relating to a specific disease, and a risk score of 2-3 can be associated with a moderate or medium risk of complications. A clinical risk score of 4-5 can be associated with a high or severe risk of complications, and is often the highest level of risk scoring. In some embodiments, the different levels of risk are associated with different numbers or different designations. In yet further embodiments, the levels of risk are divided into more or less than the three levels (i.e., low, moderate, and high) discussed above. Data can be acquired from several patients at several care facilities, and the data can be adjusted, based on the clinical results, including the clinical risk score, to more accurately compare patients or treatments with other patients having the same, or similar, conditions. Comparing the clinically risk adjusted results can provide a more accurate representation of the patients' conditions and the care facility's performance.

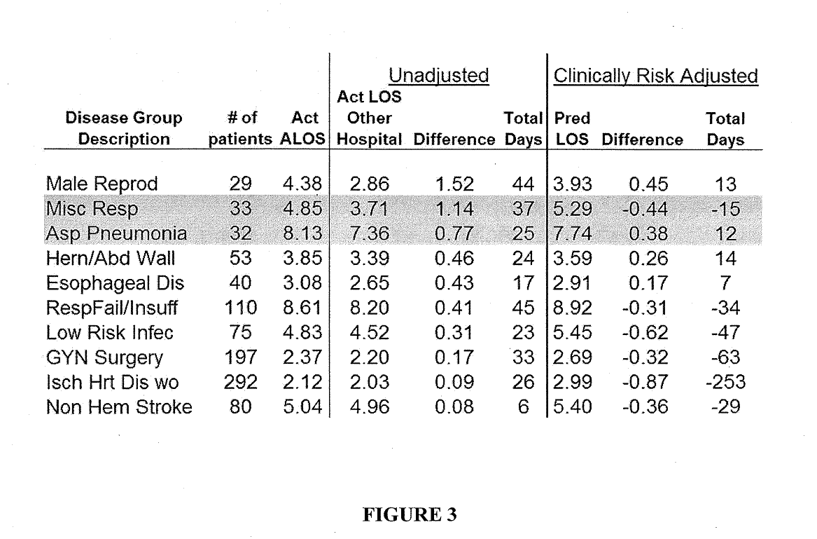

For example, FIG. 3 is a chart that provides, for a particular number of patients at a care facility, the actual average length of stay (ALOS) in comparison with the actual length of stay (Act LOS) of patients at other hospitals and with clinically risk adjusted predictions of the length of stay (Pred LOS). The chart highlights some advantages of projecting the length of stay based on clinical data, such as lab results, instead of projecting the length of stay based solely on the disease for which the patient was admitted. For example, as can be seen by the highlighted row for miscellaneous respiratory diseases, an exemplary care facility had 33 patients that were admitted with a miscellaneous respiratory disease. The 33 patients had an average LOS at the care facility of 4.85 days.

The actual average length of stay of other patients that were admitted to other hospitals for a miscellaneous respiratory disease was 3.71 days. The patients at the exemplary care facility were staying, on average, 1.14 days more than at other hospitals. For the 33 patients, there was an aggregate difference of 37 days (i.e., 1.14 day for each of the 33 patients) between other hospitals performance and the exemplary care facility's performance. Large differences like this can create complications with facility and resource planning and maintenance. The comparison also suggests that the exemplary care facility may not be treating patients as efficiently as other hospitals.

However, when the projected LOS was based on clinical data, such as with lab results used to designate a clinical risk associated with each individual patient, the predicted length of stay was 5.29 days per patient. As stated above, however, the exemplary care facility was releasing the patients after an average of 4.85 days, which was about 0.44 days per patient, or a total of about 15 days, less than the projections. While the projected calculation was still off a little, the clinically risk adjusted projections cut the difference of predicted LOS and actual LOS from 37 days to 15 days. The more accurate projections can allow for more efficient use of limited facilities and increased patient care.

Additionally, when the exemplary care facility is compared to other hospitals without clinical data adjustments, it appears the hospital is not performing as well as other hospitals. However, when the clinical data is considered, the data shows that the exemplary care facility is actually able to release patients, on average, prior to the projected length of stay. This would suggest that the exemplary care facility is performing better than other hospitals. Such a dramatic difference between projections can be due to a number of reasons, one of which is the possibility that the exemplary care facility is receiving patients with a higher clinical risk than other hospitals. Patients with higher clinical risks may have to remain in the care facility longer than those with lower clinical risks. Although the disease classification is the same (i.e., miscellaneous respiratory disease), the mere designation of a disease does not necessarily provide the specificity that is attainable by adjusting LOS projections based on clinical data. Each patient is admitted with varying degrees of the disease, and each may have different lab results. Accounting for these differences, through the methods and systems described herein, can improve accuracy of LOS projections, patient care, and care facility performance.

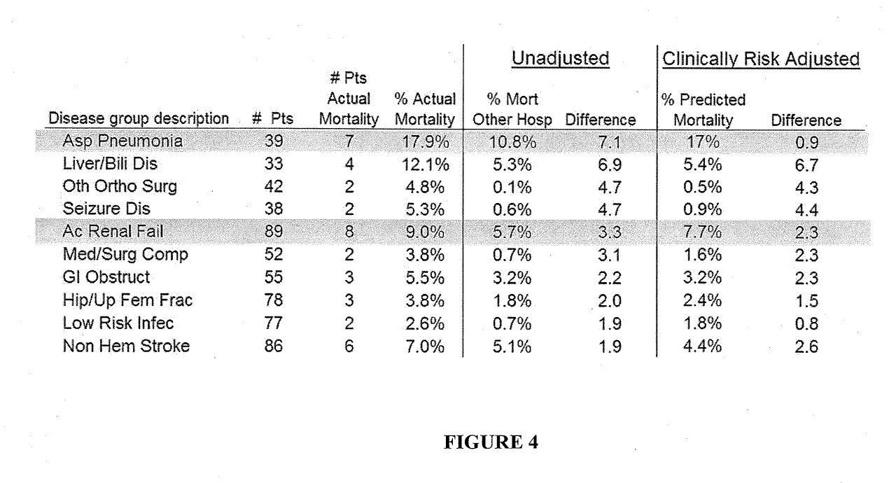

FIG. 4 provides a chart with data similar to that of FIG. 3. However, in FIG. 4, mortality rate of a facility is compared with that of other hospitals and with that of a clinically risk adjusted projection. FIG. 4 highlights a row with information relating to renal failure among patients. The actual mortality rate for renal failure at the care facility was about 9.0%, which is significantly more than the 5.7% at other hospitals. The clinically risk adjusted projections provide a mortality rate of 7.7%, which is closer to the actual rate of 9.0% than a comparison with other hospitals. In such instances, the performance of the care facility can be compared with that of other facilities and any benchmarks that are established for proper treatment of a particular disease. Such a comparison may identify concerns or opportunities for improvement in treatment by a care facility.

While the above description regarding clinically risk adjusted projections is provided as an example of use of clinical risk adjustment to compare length of stay and mortality, with several embodiments that provide exemplary values, these constructs can also be used to provide risk adjusted rates of laboratory identified complications as described herein. The above description is not intended to limit applications or embodiments of the present disclosure when used in conjunction with the systems and methods described herein. Moreover, the above exemplary description should not limit embodiments of the systems and methods described herein when used in conjunction with other methodologies similar to clinically risk adjusted projections.

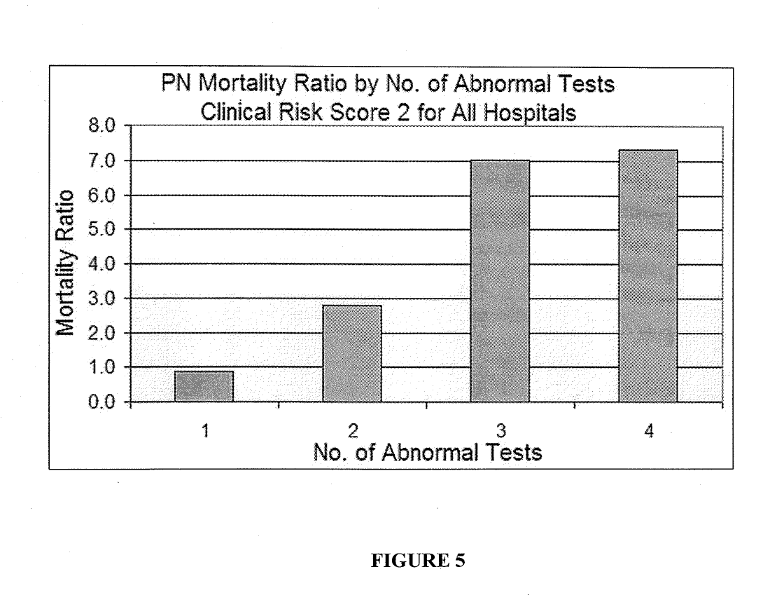

In comparing laboratory identified complications, FIG. 5 depicts a chart that demonstrates a clear pattern, across several care facilities, linking increasing frequency of abnormal lab results to higher mortality ratios with respect to pneumonia (PN). As illustrated, for pneumonia, mortality ratios are below three for two or less abnormal test results for patients with a clinical risk score of two. However, when such patients start presenting with three or more abnormal test results, the mortality ratio jumps to seven and above. Such results can be retrospectively analyzed for determining risk or complication factors and compared across care facilities, patient groups, or within departments of a facility.

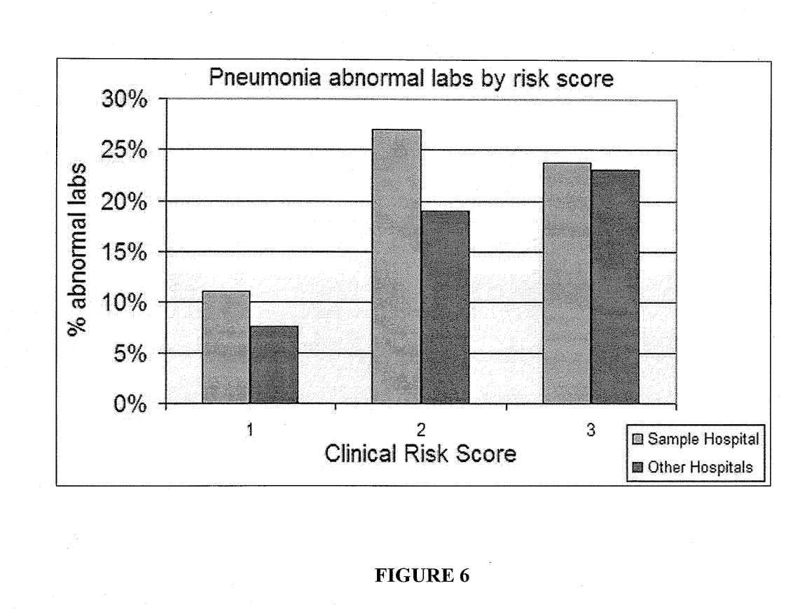

FIG. 6 depicts the exemplary results for a specific care facility correlating the percentage of pneumonia patients presenting with abnormal labs and the associated clinical risk score. As mentioned above, the clinical risk score reflects the severity of the condition of the patient. Presentation of results similar to this chart can be used to compare a care facility with the aggregate data for other care facilities, and improvements can be made in the care facility based on such comparisons.

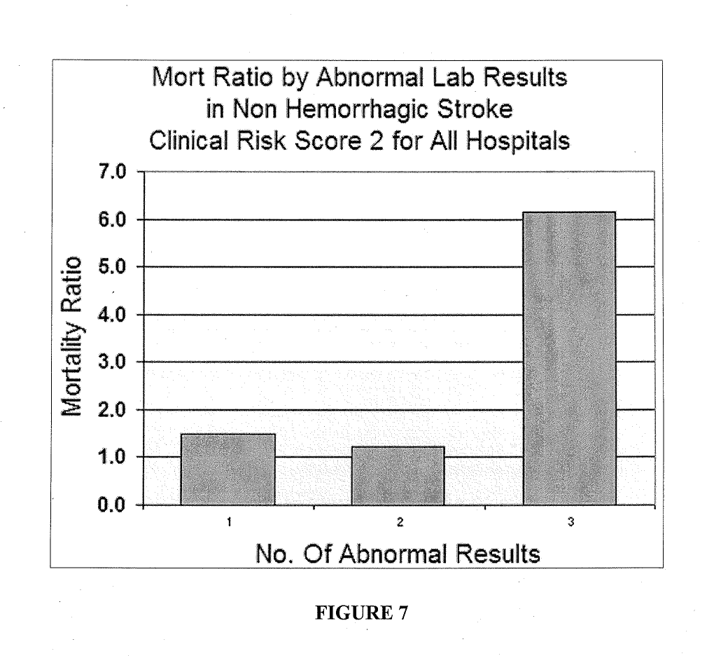

FIG. 7 depicts another exemplary chart that demonstrates a clear pattern, across several care facilities, linking increasing frequency of abnormal lab results to higher mortality ratios in nonhemorrhagic stroke complications. Similar comparisons, based on lab results can be provided for different patient groups or internally among different divisions or branches of a single care facility. As depicted, the mortality ratio jumps from under two for patients with two or fewer abnormal lab results to above six for patients with three abnormal lab results.

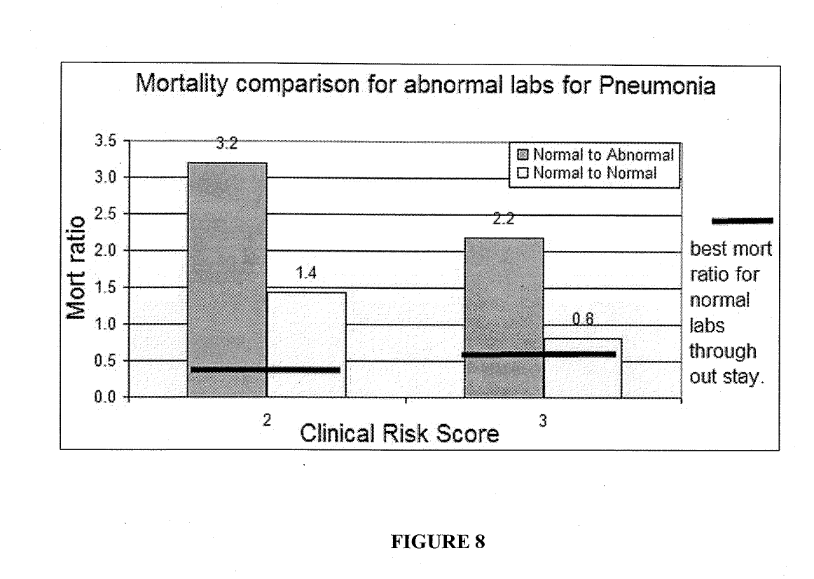

FIG. 8 illustrates a chart that demonstrates a clear pattern linking the development of abnormal labs to higher mortality ratios for patients having a clinical risk score of 2 or 3 and having lab results that move from normal (for example, upon admittance of the patient to the care facility) to abnormal. Also shown are mortality ratios for patients having normal lab results throughout the patient's stay at the care facility.

FIG. 9 is a chart providing examples of lab data that can be used, in some embodiments, for determination of risk or complication factors. Results from these data can be used retrospectively to identify complications that arose during a patient's stay at a care facility for treatment of the patient, and these data can be used to analyze the progression of a patient during the patient's stay at the care facility for incorporation into subsequent benchmarking, or similar, considerations.

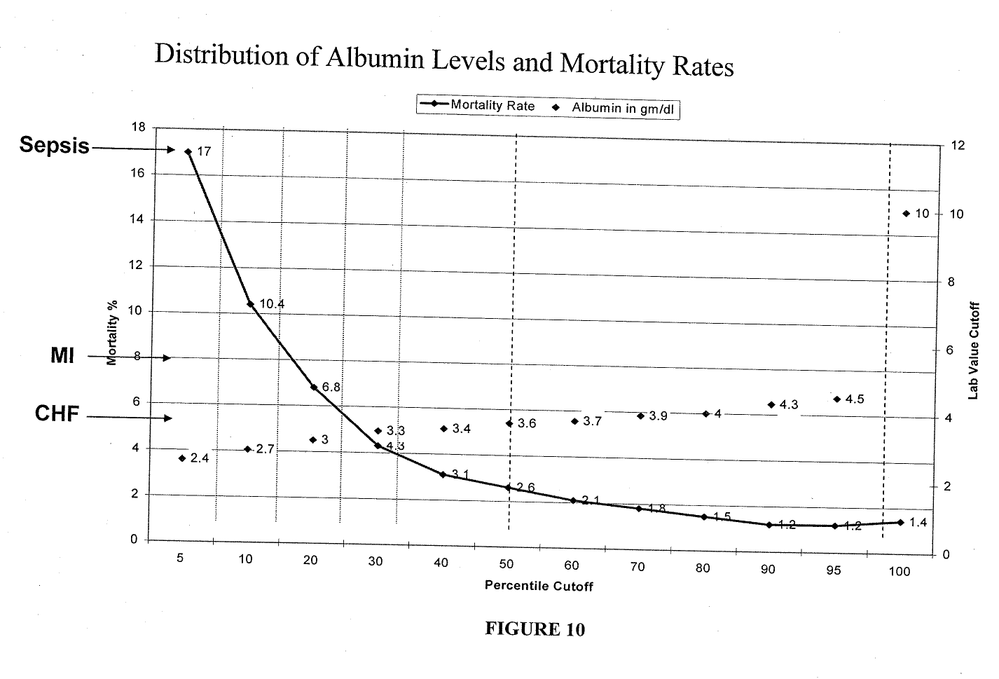

FIG. 10 depicts an example in which mortality rates are plotted against various albumin levels with associated percentile cutoffs. Albumin levels can be low in many diseases, and albumin testing is used in a variety of settings to help diagnose disease, to monitor changes in health status with treatment or with disease progression, and as a screen that may serve as an indicator for other kinds of testing. For example, low albumin levels can suggest liver disease, and other liver enzyme tests can be ordered to determine exactly which type of liver disease. Low albumin levels are also reflected in diseases in which the kidneys cannot prevent albumin from leaking from the blood into the urine and being lost. In this case, the amount of albumin (or protein) in the urine also may be measured. Low albumin levels can also be present in inflammation, shock, and malnutrition. Additionally, low albumin levels may also suggest conditions in which the patient's body does not properly absorb and digest protein (such as in Crohn's disease or sprue) or in which large volumes of protein are lost from the intestines. All of these complications can be detected through the lab results, and a report regarding the same can be provided relating the results to risk or complication factors that are based on similar conditions that have been retrospectively analyzed and stored in the database.

Identification of abnormal lab results can be acquired, in some embodiments, by a local, regional, or national regulatory agency to compile data relating to quality of patient care by individual care facilities, by several care facilities, or among various patient groups. The lab results of individual patients can be compared by the regulatory agency to provide feedback to the individual care facilities. In other embodiments, a service provider can acquire the lab results and perform a similar function as the regulatory agency described above. In yet other embodiments, the lab results can be acquired by a quality control department of the care facility, in which a comparison is conducted on information provided to by care facility relating to treatment and lab results data for a plurality of care facilities.

Retrospective analysis by a regulatory agency, service provider, or individual care facility can analyze data for continuous quality improvement and can automatically incorporate the diagnosis that comes with the billing code. Data can be accumulated in a central database, or a local database housed at the facility, identifying how often a particular complication occurred for a certain number of patients. Results across several care facilities can be used to compare how well a particular care facility is doing over time and to identify opportunities to improve the treatment process at that particular care facility. This analysis can then become a benchmark to compare other care facilities and can continually be informed and adjusted by the results provided by each of the participating facilities. The continuous retroactive analysis process can provide a comprehensive data set that can analyze multiple factors for continuous quality improvement. The hospital can then set operational policies and protocols based on trends that are presented in the retrospective analysis.

The retrospective analysis permits prophylactive, concurrent treatment by identification of complications that arise during patients' stay at a care facility resulting in prolongation of patients' stay or death. The systems and methods described herein reveal advantages in retrospectively measuring laboratory data over time on the levels of an individual patient, of a care facility, and of a local, regional, or global healthcare industry. In many instances, the lab data indicates the operation of the body system, and in some instances, the degree that an adverse outcome is expected or anticipated given the lab data. In some embodiments, the systems and methods further calibrate, or improve correlation between, the laboratory data with the operation of a body function and/or complications associated with the body and project a mortality risk, or other result, based on the lab data and associated complications.

Although preferred embodiments of the disclosure have been described in detail, certain variations and modifications will be apparent to those skilled in the art, including embodiments that do not provide all the features and benefits described herein. It will be understood by those skilled in the art that the present disclosure extends beyond the specifically disclosed embodiments to other alternative or additional embodiments and/or uses and obvious modifications and equivalents thereof. In addition, while a number of variations have been shown and described in varying detail, other modifications, which are within the scope of the present disclosure, will be readily apparent to those of skill in the art based upon this disclosure. It is also contemplated that various combinations or subcombinations of the specific features and aspects of the embodiments may be made and still fall within the scope of the present disclosure. Accordingly, it should be understood that various features and aspects of the disclosed embodiments can be combined with or substituted for one another in order to form varying modes of the present disclosure. Thus, it is intended that the scope of the present disclosure herein disclosed should not be limited by the particular disclosed embodiments described above.

What is claimed is:

1. A method of identifying complications of a patient of a care facility, the method comprising:
obtaining at least a first set of laboratory data of a first patient and a second set of laboratory data of the first patient;
determining a data trend that represents a difference between the first set of data and the second set of data;
obtaining at least a first set of laboratory data of a second patient;
comparing at least part of the first set of laboratory data of the second patient with the data trend to calculate trends associated with a plurality of complications;
assigning a risk value, based on the data trend, that represents a likelihood that the patient has developed or will develop at least one complication; and
outputting, to an output module, the risk value and the at least one complication.

2. The method of claim 1, wherein the calculated trends are calculated based on the laboratory data from a plurality of patients at a plurality of care facilities.

3. The method of claim 1, wherein the first and second sets of data of the first patient include data from at least one of a blood urea nitrogen (BUN), creatinine, glucose, albumin, potassium, bilirubin, creatinine phosphokinase (CPK), hemoglobin, sodium, and white blood cell (WBC) test.

4. The method of claim 1, wherein the complications associated with the calculated trends include at least one of acute renal failure, anemia, heart failure, myocardial infarction, nonhemorrhagic stroke, pancreas disease, renal disease, asthma, acute liver disease, arterial and/or aneurysm complications, fractures, gastro-intestinal tract complications or obstruction, liver and/or biliary disorder, arrhythmia, chronic lung disorders, and pneumonia.

5. The method of claim 1, wherein the first set of data of the first patient represents a baseline value of laboratory data for the first patient upon admittance of the patient to a care facility.

6. The method of claim 5, wherein the risk value assigned to the second patient comprises a low, moderate, or high likelihood designation based on a comparison of the data trend with the baseline value.

7. The method of claim 6, wherein the low likelihood designation is assigned to a patient whose data trend has progressed to between about 25% and about 40% from the baseline value to a threshold value associated with a presence of a complication.

8. The method of claim 6, wherein the moderate likelihood designation is assigned to a patient whose data trend has progressed to between about 35% and about 60% from the baseline value to a threshold value associated with a presence of a complication.

9. The method of claim 6, wherein the high likelihood designation is assigned to a patient whose data trend has progressed between about 50% and about 75% from the baseline value to a threshold value associated with a presence of a complication.

10. The method of claim 1, wherein the risk value assigned to the second patient comprises a percentage of the likelihood that the patient has developed or will develop a complication.

11. A method of identifying the likelihood of complications of a patient, the method comprising:
obtaining at least a set of the patient's laboratory data;
comparing at least a part of the patient's laboratory data to threshold values associated with a plurality of complications, the threshold values being based on laboratory data from a plurality of patients at a plurality of care facilities;
assigning a risk value, based on the patient's laboratory data in view of the threshold values, that represents a likelihood that the patient has developed or will develop at least one complication; and
outputting, to an output module, the risk value and the at least one complication.

12. The method of claim 11, wherein the patient's laboratory data include data from at least one of a blood urea nitrogen (BUN), creatinine, glucose, albumin, potassium, bilirubin, creatinine phosphokinase (CPK), hemoglobin, sodium, and white blood cell (WBC) test.

13. The method of claim 11, wherein the complications associated with the threshold values include at least one of acute renal failure, anemia, heart failure, myocardial infarction, nonhemorrhagic stroke, pancreas disease, renal disease, asthma, acute liver disease, arterial and/or aneurysm complications, fractures, gastrointestinal tract complications or obstruction, liver and/or biliary disorder, arrhythmia, chronic lung disorders, and pneumonia.

14. The method of claim 11, wherein the risk value assigned to the patient comprises a low, moderate, or high likelihood designation based on a comparison of the patient's laboratory data with the threshold value.

15. The method of claim 11, wherein the risk value assigned to the patient comprises a percentage of the likelihood that the patient has developed or will develop a complication.

16. A system, for determining a likelihood of a patient outcome, comprising:
a database, comprising at least one of a result and a trend of laboratory data, the at least one of the result and the trend being associated with an outcome of a plurality of patients;
a processor that receives laboratory results for a patient, compares the results with the at least one of the result and the trend to determine a likelihood of the patient's outcome, and outputs a signal indicative of the likelihood; and
an output module, connected to the processor, configured to receive the signal and to communicate the likelihood of the patient's outcome.

17. The system of claim 16, wherein the outcome comprises whether the patient has developed or will develop a complication.

18. A computer readable medium, comprising instructions that, when executed, cause a computing device to perform a method comprising:
obtaining at least a set of a patient's laboratory data;
comparing at least part of the patient's laboratory data to threshold values associated with a plurality of complications, the threshold values being based on laboratory data from a plurality of patients at a plurality of care facilities;
assigning a risk value, based on the patient's laboratory data in view of the threshold values, that represents a likelihood that the patient has developed or will develop at least one complication; and
generating an output signal indicative of the risk value and the at least one complication.
